(19) United States
(12) Patent Application Publication
(10) Pub. No.: US 2016/0311045 A1
(43) Pub. Date: Oct. 27, 2016

(54) SYSTEM AND METHOD FOR SETTING WELDING PARAMETERS

(71) Applicant: HOBART BROTHERS COMPANY, Troy, OH (US)

(72) Inventor: Darrell Lee Sickels, Troy, OH (US)

(21) Appl. No.: 14/694,329

(22) Filed: Apr. 23, 2015

(51) Int. Cl. B23K 9/095

(52) U.S. Cl. CPC B23K 9/095

(57) ABSTRACT

Systems and methods for setting welding parameters are provided. For example, in certain embodiments, a method includes setting a material thickness of a work piece to be welded based on adjustment of a first input device of a user interface of a welding system when a second input device of the user interface is in a first position, setting a power output of the welding system based on adjustment of the first input device of the user interface of the welding system when the second input device of the user interface is not in the first position, setting a wire feed speed output of the welding system based on adjustment of the second input device of the user interface when the second input device of the user interface is not in the first position; and controlling operating parameters of the welding system in accordance with the settings of the material thickness of the work piece to be welded, the power output, and/or the wire feed speed output.

### BACKGROUND

The present disclosure generally relates to systems and methods for setting welding parameters.

A common metal welding technique employs the heat generated by electrical arcing to transition a work piece to a molten state, to facilitate a welding process. One technique that employs this arcing principle is wire feed welding. At its essence, wire feed welding involves routing welding current from a power source into an electrode that is brought into close proximity with the work piece. When close enough, current arcs from the electrode to the work piece, completing a circuit and generating sufficient heat to weld the work piece. Often, the electrode is consumed and becomes part of the weld itself. Thus, new wire electrode is advanced, replacing the consumed electrode and maintaining the welding arc. If the welding device is properly adjusted, the wire feed advancement and arcing cycle progresses smoothly, providing a good weld.

Traditionally, during a welding operation, an operator selects the level and types of resources provided to the weld location, depending, of course, on the particulars of the weld and the materials being welded. For instance, an operator may select between various kinds and sizes of wire electrode, ranging from the diameter of wire to the material the wire electrode is made of Different kinds of wire electrode, however, perform well at different operational settings of the welding device. That is, different kinds of wire electrodes perform well within different voltage range of values and wire feed speeds, for instance. For example, when welding 22 gauge mild steel, a 0.023 inch mild-steel wire electrode may be fed with a wire feed speed of 200 inches per minute with an arc voltage of 14 volts. However, when using a 0.030 inch mild steel wire electrode for welding 22 gauge mild steel, the electrode may be feed at 130 inches per minute with an arc voltage of 16 volts

Conventionally, welding devices rely on the knowledge and acumen of the operator to select the most appropriate voltage and wire feed settings for the wire electrode being used and weld conditions. Unfortunately, in many cases, the weld operator is a novice to the field, especially in the case of portable welding devices. If the operator does not properly adjust the voltage and wire feed speed settings, the arcing may not be sufficient to produce a good weld, or any weld at all. Furthermore, in traditional devices, the wire feed speed control and the voltage control are wholly independent from one another, thus making it difficult for the operator to adjust both parameters while a weld is progressing.

### BRIEF DESCRIPTION

In one embodiment, a welding system includes a power source configured to generate power and deliver the power to a welding torch, a welding wire feeder configured to advance wire electrode into the welding torch at a rate of advancement, and an interface including a first input device configured to receive an input relating to a parameter of the power and an input relating to a thickness of a material to be welded and a second input device configured to receive an input relating to the rate of advancement of the wire electrode.

In another embodiment, a welding system includes a power source configured to generate power and deliver the power to a welding torch, an interface having a first input device configured to receive an input relating to a parameter of the power and an input relating to a thickness of a material to be welded and a second input device configured to receive an input relating to a rate of advancement of a wire electrode, and control circuitry configured to output control signals to the power source and a welding wire feeder based on the input relating to a thickness of a material to be welded when the second input device is in a first position.

In another embodiment, a method includes setting a material thickness of a work piece to be welded based on adjustment of a first knob of a user interface of a welding system when a second knob of the user interface is in a first position, setting a power output of the welding system based on adjustment of the first knob of the user interface of the welding system when the second knob of the user interface is not in the first position, setting a wire feed speed output of the welding system based on adjustment of the second knob of the user interface when the second knob of the user interface is not in the first position; and controlling operating parameters of the welding system in accordance with the settings of the material thickness of the work piece to be welded, the power output, and/or the wire feed speed output.

In a further embodiment, a system includes control circuitry of a welding system, wherein the control circuitry is configured to receive a first signal from a first input device, wherein the first signal is indicative of a material thickness of a work piece to be welded or is indicative of a desired power output of the welding system, receive a second signal from a second input device, wherein the second signal is indicative of a desired wire feed speed of the welding system or is indicative of a simplified operating mode of the welding system, and output control signals to the welding system based on the first signal and the second signal, wherein the first signal is indicative of the desired power output of the welding system when the second signal is indicative of the desired wire feed speed of the welding system, and the first signal is indicative of the material thickness of the work piece to be welded when the second signal is indicative of the simplified operating mode of the welding system.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of a welding system, having an interface configured to enable adjustment of welding parameters of the welding system, in accordance with aspects of the present disclosure;

FIG. 2 is a schematic diagram of an embodiment of control circuitry and a user interface for a MIG or flux cored welding process, illustrating a dual knob configuration of the user interface, in accordance with aspects of the present disclosure;

FIG. 3 is a front view of an embodiment of the interface for a MIG or flux cored welding process including adjustment knobs configured for a single knob control mode and a dual knob control mode, in accordance with aspects of the present disclosure; and

FIG. 4 is a front view of an embodiment of the interface for a MIG or flux cored welding process including adjustment knobs configured for a single knob control mode and a dual knob control mode, in accordance with aspects of the present disclosure.

### DETAILED DESCRIPTION

Embodiments of the present disclosure include a system and method for controlling operating parameters of a welding system. For example, welding system (e.g., a metal-inert-gas (MIG) and/or flux cored arc welding (FCAW) welding system) incorporating the present technique can include a dual knob user interface configured for dual knob control and single knob control. In other words, in a first control mode, only one of the two knobs of the user interface may be used to adjust operating parameters of a welding system and, in a second control mode, both knobs of the user interface may be used to adjust operating parameters of the welding system. To this end, as described in further detail below, the welding system may include an “easy mode” setting (e.g., “EZ mode”) or other simplified mode to enable the first control mode. When the easy mode setting is selected, only one of the two knobs of the user interface is used to adjust operating parameters of a welding system. For example, in the easy mode setting, the one knob may be used to select a thickness or gauge of a work piece welded by the welding system. In this easy mode setting, control circuitry of the welding system may automatically select appropriate voltage and wire feed speed settings based on the selected thickness or gauge of the work piece. In the second control mode, the welding system is not in the easy mode setting, and both knobs of the user interface are used to adjust operating parameters of the welding system. For example, in the second control mode, a first knob of the user interface may be used to adjust a voltage output of the welding system, and a second knob of the user interface may be used to adjust a wife feed speed of the welding system.

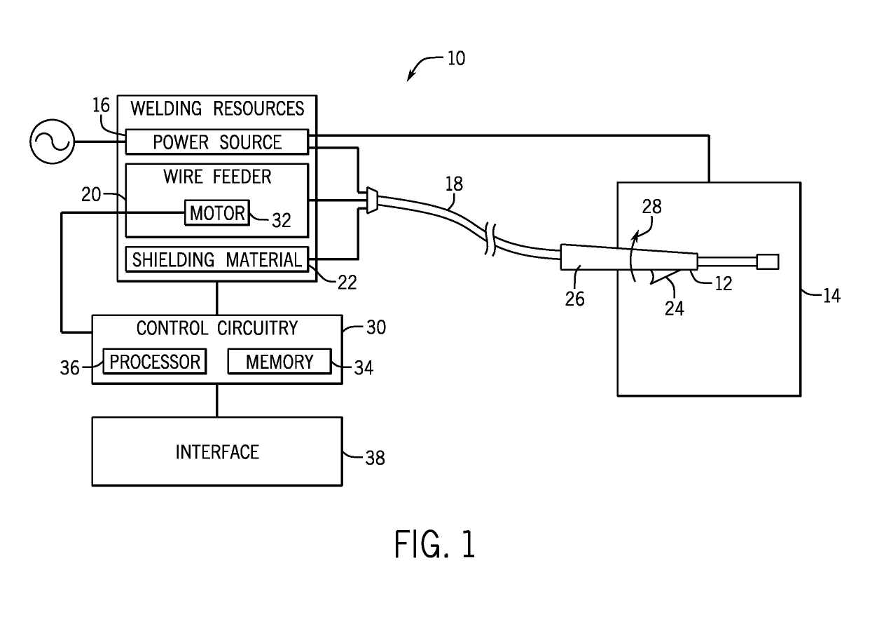

Turning now to the figures, FIG. 1 illustrates a welding system 10 that includes a welding torch 12 that defines the location of the welding operation with respect to a work piece 14. Placement of the welding torch 12 at a location proximate to the work piece 14 allows electrical current provided by a power source 16, which converts incoming alternating current (AC) power to an appropriate direct current (DC) power-and routed to the welding torch 12 via a welding torch cable 18, to arc from the welding torch 12 to the work piece 14. In summary, this arcing completes an electrical circuit from the power source 16, to the welding torch 12 via the welding torch cable 18, to a wire electrode, to the work piece 14, and at its conclusion, back to the power source 16. This arcing generates a relatively large amount of heat causing the work piece 14 and/or filler metal to transition to a molten state, facilitating the weld.

To produce electrical arcing, the exemplary welding system 10 includes a wire feeder 20 that provides a consumable wire electrode to the welding torch cable 18 and, in turn, to the welding torch 12. The welding torch 12 conducts electrical current to the wire electrode via a contact tip (not shown) located in a neck assembly of the welding torch 12, leading to arcing between the egressing wire electrode and the work piece 14.

To shield the weld area from contaminants during welding, to enhance arc performance, and to improve the resulting weld, the welding system 10 may include a gas source 22 that feeds an inert shielding gas to the welding torch 12 via the welding torch cable 18. For example, when the welding system 10 is a MIG welding system, the welding system 10 may include the gas source 22. It is worth noting, however, that a variety of shielding materials, including various fluids and particulate solids, may be employed to protect the weld location. Additionally, certain wire electrodes are designed to operate without a separate shielding material (e.g., external gas supply). For example, the welding system 10 may also be a FCAW welding system, which may not use a separate shielding material. As discussed below, the disclosed control schemes may be used with both MIG and FCAW welding systems 10. Indeed, the disclosed control schemes may enable the use of a single welder (e.g., power source 16 and/or wire feeder 20) to conveniently perform both MIG and FCAW welding processes.

Advancement of these welding resources (e.g., welding current, wire-electrode, and shielding gas) is effectuated by actuation of a trigger 24 secured to a handle 26 of the welding torch 12. By depressing the trigger 24 (arrow 28), a switch disposed within the trigger 24 is closed, causing the transmission of an electrical signal that commands promotion of the welding resources into the welding torch cable 18. For example, depressing the trigger 24 sends a signal to control circuitry 30, which, in turn, activates a motor 32 that advances wire electrode into the welding torch cable 18, opens a valve to allow the flow of shielding material, and commands the power source 16 to output the desired level of power to the wire electrode. In certain embodiments, the control circuitry 30 includes memory components 34, to store programming instructions, command programs, appropriate data, etc. The control circuitry 30 also includes a processing device, such as a processor 36, among others types of devices, to effectuate control of the welding system 10.

To adjust operating parameters of the welding system 10, a user interface 38 may be included as part of the system 10. The user interface 38 is the component by which a user or an operator interacts with the welding system 10. In certain embodiments, the user interface 38 may be integrated with the power source 16, the wire feeder 20, or a welding machine (e.g., welder) having the power source 16 and the wire feeder 20. In other embodiments, the user interface 38 may be integrated with another component, or the user interface 38 may be a stand-alone component (e.g., a wireless user interface). The user interface 38 may also include input devices. For example, the input devices may be adjustable (e.g., physically adjustable) input devices, such as switches, pushbuttons, dials, scroll wheels, sliding adjustors, and so forth. The input devices may alternatively or additionally include touch screens, touch pads, or other input devices. Indeed, the input devices of the user interface 38 may be any form of transducer that converts a physical interaction with the user interface 38 into an electrical signal input. In certain embodiments, the user interface 38 may also include visual indicators, such as a display screen to display graphics, buttons, icons, text, windows, and similar features relating to the setting and displaying of welding parameters. For example, the user interface 38 may be a graphical interface, and may display graphical indicators of welding parameters such as voltage, amperage, and wire feed speed in varying colors in the case that the system is operating under overvoltage, overamperage, or overtemperature conditions.

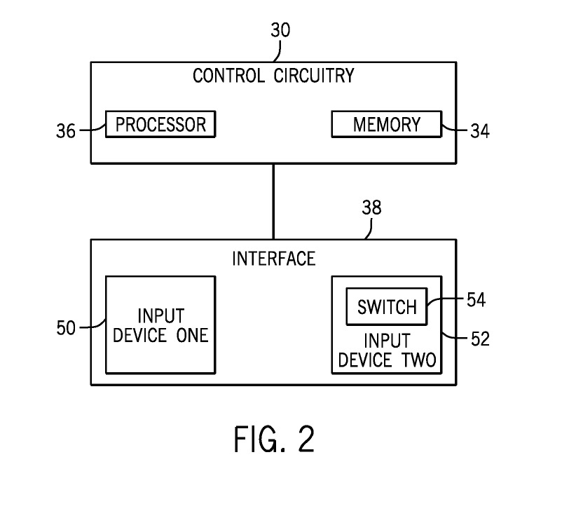

As will be discussed henceforth and illustrated by FIGS. 2-4, in certain embodiments, the user interface 38 may include two user input devices (e.g., physically adjustable or non-physically adjustable input devices), such as two knobs configured for both a dual knob control scheme (e.g., dual input device control scheme) and a single knob control scheme (e.g., a single input device control scheme). In the dual input device control scheme, both input devices (e.g., knobs or other adjustable devices) are used to adjust operating parameters of the welding system 10. In the single input device (e.g., knob) control scheme, only one of the input devices (e.g., knobs) is used to adjust operating parameters of the welding system 10. While the following discussion describes input devices as knobs, the input devices described below may also have other configurations, embodiments, or features. For example, the input devices of the user interface 38 may be dials, switches, touch screens, touch pads, rocker panels, roller balls, scroll wheels, sliding adjustors, joy sticks, or other input devices. Indeed, as mentioned above, the input devices may be physically adjustable devices or non-physically adjustable devices.

FIG. 2 is a schematic diagram of the user interface 38 having a first input device 50 (e.g., a first adjustable device, such as a first knob) and a second input device 52 (e.g., a second adjustable device, such as a second knob). As mentioned above, the user interface 38 is configured to enable two control schemes (e.g., control schemes of the control circuitry 30). A first control scheme enables adjustment of operating parameters of the welding system 10 using the first input device 50 but not the second input device 52, and the second control scheme enables adjustment of operating parameters of the welding system 10 using the first input device 50 and the second input device 52. To this end, the second input device 52 includes an integrated switch 54. The integrated switch 54 may be opened or closed based on the position or adjustment of the second input device 52. For example, as discussed in further detail below, the integrated switch 54 of the second input device 52 may be opened when the second input device 52 is in a first position, and the integrated switch 54 of the second input device 52 may be closed when the second input device 52 is not in the first position.

When the integrated switch 54 is opened, the first control scheme of the control circuitry 30 may be enabled. For example, the integrated switch 54 and/or the second input device 52 may send a signal to the control circuitry 30 to enable the first control scheme. When the first control scheme is enabled, the first input device 50 (but not the second input device 52) is used to adjust operating parameters of the welding system 10. For example, the first input device 50 may be used to select a thickness of the work piece 14 to be welded by the welding system 10, and the control circuitry 30 may receive a signal from the first input device 50 providing an indication of the thickness of the work piece 14 to be welded by the welding system 10, and the control circuitry 30 may automatically set appropriate voltage and wire feed speed and/or amperage welding parameters for the welding system 10 based on the selected thickness of the work piece 14. When the integrated switch 54 is closed (e.g., when the second input device 52 is not in the first position), the second control scheme of the control circuitry 30 may be enabled. That is, the integrated switch 54 and/or the second input device 52 may send a signal to the control circuitry 30 to enable the second control scheme. When the second control scheme is enabled, the first input device 50 and the second input device 52 are both used to adjust operating parameters of the welding system 10. For example, the first input device 50 may be used to adjust a voltage and/or current output of the welding system 10 (e.g., the power source 16), and the second input device 52 may be used to adjust a wire feed speed of the welding system 10 (e.g., the wire feeder 20). In other words, the first input device 50 may send a signal to the control circuitry 30 indicative of a desired voltage and/or current output of the welding system 10, and the control circuitry 30 may provide an output signal to the welding system 10 (e.g., the power source 16) based on the signal indicative of the desired voltage and/or current output received from the first input device 50. Similarly, the second input device 52 may send a signal to the control circuitry 30 indicative of a desired wire feed speed of the welding system 10, and the control circuitry 30 may provide an output signal to the welding system 10 (e.g., the wire feeder 20) based on the signal indicative of the desired wire feed speed received from the second input device 52.

As will be appreciated, the dual control schemes enabled by the disclosed user interface 38 and control circuitry 30 enable improved functionality, operability, and flexibility of the welding system 10. For example, the welding system 10 may be used for both MIG and FCAW welding processes. In other words, one welder (e.g., power source 16 and wire feeder 20) may be used for both MIG and FCAW welding processes, while enabling simplified and flexible control of operating parameters of the welding system 10. In certain embodiments, the first control scheme (e.g., single input device control scheme) may be used for a FCAW welding process, while the second control scheme (e.g., dual input device control scheme) may be used for a MIG welding process (or a FCAW welding process). The welding system 10 with the disclosed control schemes may also reduce manufacturing and retailing complexity and cost, as one welder (e.g., power source 16 and wire feeder 20) may be used for multiple applications, thereby reducing the need for multiple different systems to perform different welding processes. Additionally, the simplicity and flexibility of both control schemes may also appeal to multiple welding operators having varying levels of welding skill.

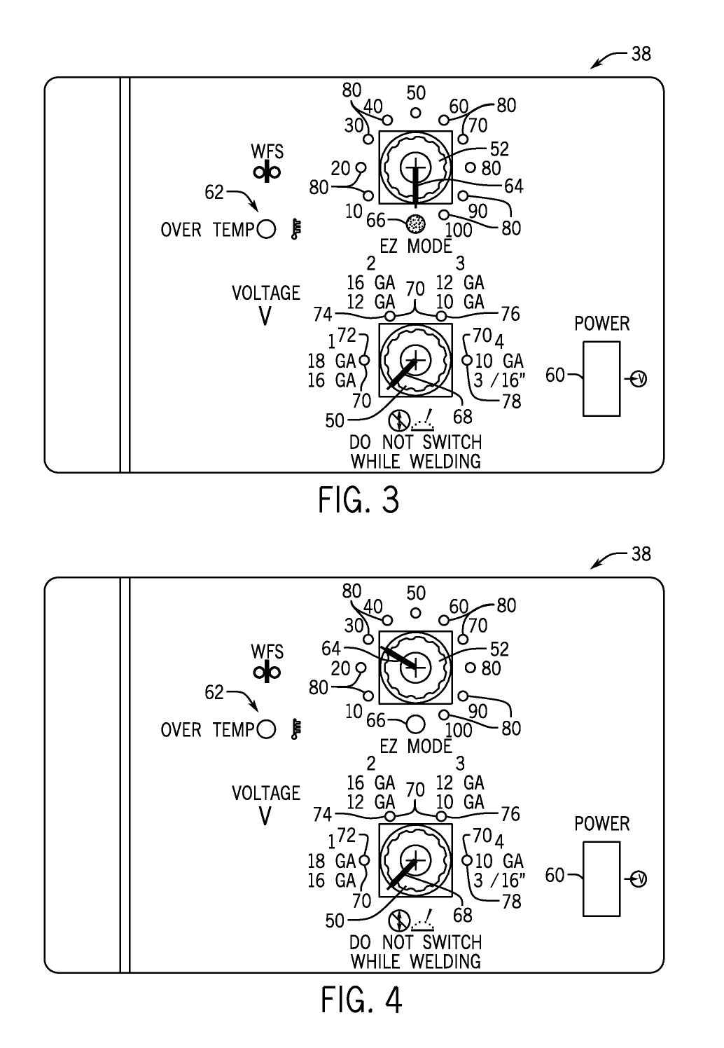

FIG. 3 is a front view of an embodiment of the user interface 38, illustrating the first input device 50 and the second input device 52 of the user interface 38, wherein the first input device 50 is a first knob, and the second input device 52 is a second knob. In the illustrated embodiment, the user interface 38 includes other indicators and input devices, such as a power button 60 for turning power of the power source 16 and/or wire feeder 20 on and off The user interface 38 also includes a temperature indicator 62 that may illuminate when a threshold temperature of a component (e.g., a power transformer) of the welding system 10 exceeds a threshold temperature. Of course, it will be appreciated that the user interface 38 may have other input devices, visual indicators, auditory indicators, displays, and so forth.

As discussed above, the user interface 38 has the first knob 50 and the second knob 52, which are configured for dual functionality. More specifically, the first knob 50 and the second knob 52 may have different functionalities based on the control scheme of the control circuitry 30 that is enabled. In the illustrated embodiment, the first and second knobs 50 and 52 are positioned in a setting to enable the first control scheme of the welding system 10, which may be used in a FCAW welding process (thereby eliminating the need for a separate shielding gas source). More specifically, the second knob 52 is in the first position discussed above, which opens the integrated switch 54 of the second knob 52 and initiates the first control scheme of the control circuitry 30.

The first position of the second knob 52 is verified by a position indicator 64 of the second knob 52. In particular, the position indicator 64 of the second knob 52 is aligned with a visual indicator 66 labeled “EZ Mode” (e.g., easy mode). As will be appreciated, the visual indicator 66 may illuminate when the position indicator 64 of the second knob 52 is in position shown in FIG. 3 (i.e., the first position). In other embodiments, the visual indicator 66 may provide other visual indications when the position indicator 64 of the second knob 52 is in the first position. For example, the visual indicator 66 may be a light that changes color or changes a blinking patter. In other embodiments, the visual indicator 66 may be a screen that provides an alpha-numeric indication when the position indicator 64 of the second knob 52 is in the first position. When an operator adjusts the position of the second knob 52 to the position shown in FIG. 3, the visual indicator 66 provides some visual indication, indicating that the welding system 10 is in EZ mode, and the integrated switch 54 opens, which initiates the first control scheme of the control circuitry 30.

In the first control scheme, the first knob 50 is used to adjust operating parameters of the welding system 10. While operating in the first control scheme, the second knob 52 is not used to adjust operating parameters of the welding system 10, because adjusting the second knob 52 from the first position shown in FIG. 3 will close the integrated switch 54 of the second knob 52, which will deactivate the first control scheme of the control circuitry 30. To adjust operating parameters of the welding system 10 with the first knob 50 in the first control scheme, the first knob 50 may be rotated to select a material thickness of the work piece 14 to be welded. More specifically, a position indicator 68 of the first knob 50 may be rotated to align with one of several visual indicators 70 positioned about a circumference of the first knob 50. In certain embodiments, the respective position of the first knob 50 when the first knob 50 aligns with each of the several visual indicators 70 may be discrete positions. As indicated by arrows 72, each of the visual indicators 70 corresponds with a particular material thickness or a range of material thicknesses of the work piece 14. For example, a first visual indicator 72 corresponds with a material thickness of between 18 gauge and 16 gauge. Similarly, a second visual indicator 74 corresponds with a material thickness of between 16 gauge and 12 gauge, a third visual indicator 76 corresponds with a material thickness of between 12 gauge and 10 gauge, and a fourth visual indicator 78 corresponds with a material thickness of between 10 gauge and 3/16″. It will be appreciated that, in other embodiments, the first knob 50 may include other numbers of visual indicators 70 and/or visual indicators 70 corresponding to other particular material thicknesses or ranges of material thicknesses.

When the first knob 50 is rotated to select one of the visual indicators 70, the selected visual indicator 70 may illuminate to indicate to a user that the corresponding material thickness or material thickness range has been selected. Additionally, the selected material thickness may be communicated to the control circuitry 30. Based on the selected material thickness, the control circuitry 30 may automatically adjust (e.g., increase or decrease) operating parameters of the welding system 10, such as voltage, wire feed speed, and/or amperage parameters to appropriate settings. In certain embodiments, the control circuitry 30 may adjust operating parameters of the welding system 10 according to the control scheme described in U.S. Pat. No. 8,546,728. That is, the control circuitry 30 may automatically adjust voltage, wire feed speed, and/or amperage parameters to appropriate settings based on a selected material thickness of the work piece 14. In certain embodiments, the memory 34 of the control circuitry 30 may store data related to the appropriate operating parameter settings for each material thickness or material thickness range that may be selected. As will be appreciated, the first control scheme of the welder (e.g., power source 16 and/or wire feeder 20) may simplify the input (e.g., operating parameter adjustment input) demanded of the operator or user.

FIG. 4 is a front view of an embodiment of the user interface 38, illustrating the first knob 50 and the second knob 52 of the user interface 38 positioned in a setting to enable the second control scheme of the welding system 10, which may be used in a FCAW welding process (thereby eliminating the need for a separate shielding gas source) or a MIG welding process, which utilizes separate shielding gas and a solid filler welding wire. More specifically, the second knob 52 is rotated out of the first position discussed above with reference to FIG. 3. When the second knob 52 is not in the first position, the integrated switch 54 of the second knob 52 is closed, and the second control scheme of the control circuitry 30 is initiated. As will be appreciated, the selection between FCAW and MIG welding processes when the second control scheme is activated may be made by adjusting or changing the connection of leads in the welding torch cable 18 and the work lead connection (e.g., to work piece 14) with a polarity block in the welder (e.g., power source 16 and/or wire feeder 20).

When the second knob 52 is out of the first position and the second control scheme is activated, the first and second knobs 50 and 52 are used to adjust operating parameters of the welding system 10. More specifically, the closure of the integrated switch 54 of the second knob 52 energizes a relay and resistive element of the second knob 52 (e.g., potentiometer), which enables adjustment of an operating parameter with the second knob 52. In the illustrated embodiment, the first knob 50 is used to adjust a voltage output of the power source 16, and the second knob 52 is used to adjust the wire feed speed of the wire feeder 20. In certain embodiments, the wire feed speed may be a function of the voltage, and the second knob 52 may be used to adjust the functional relationship (e.g., percentage) between the wire feed speed and the voltage.

When the second control scheme is activated, the visual indicators 70 of the first knob 50 correspond with different voltage settings. For example, the first visual indicator 72 corresponds with voltage setting of “1,” the second visual indicator 74 corresponds with a voltage setting of “2,” the third visual indicator 76 corresponds with a voltage setting of “3,” and the fourth visual indicator 78 corresponds with a voltage setting of “4.” It will be appreciated that, in other embodiments, the first knob 50 may include other numbers of visual indicators 70. Each voltage setting corresponding with the visual indicators 70 (e.g., 1, 2, 3, and 4) may correspond further with a voltage output value. For example, the voltage output value corresponding with each voltage setting may be listed in a reference chart, manual, or other reference material accompanying the welder (e.g., power source 16 and/or wire feeder 20). In other embodiments, the value or setting displayed on the user interface 38 (e.g., 1, 2, 3, and 4 in the illustrated embodiment) corresponding to each visual indicator 70 may be a voltage output value rather than a setting corresponding to a voltage value in a reference material.

The second knob 52 also has visual indicators 80, each of which corresponds to a wire feed speed value or setting. To adjust the wire feed speed, the second knob 52 is rotated until the position indicator 64 of the second knob 52 aligns with the visual indicator 80 corresponding to the desired wire feed speed setting or value. In certain embodiments, the value or setting displayed on the user interface 38 (e.g., 10, 20, 30, 40, etc.) may be indicative of a wire feed speed output value (e.g., inches per minute), or the value or setting may correspond with a respective wire feed speed output value that may be referenced in a reference material. In certain embodiments, the respective position of the second knob 52 when the second knob 52 aligns with each of the visual indicators 80 may be discrete positions. However, in other embodiments, the second knob 52 may rotate continuously to, between, and/or through positions associated with each of the visual indicators 80. Additionally, the visual indicators 80 may also be configured to provide a visual indication (e.g., illuminating, changing colors, blinking, etc.) when the second knob 52 is not in the first position, thereby indicating that the second knob 52 is configured for use in the dual input device (e.g., dual knob) control scheme and that the second knob 52 may be used to select a desired wire feed speed output value.

As discussed in detail above, embodiments of the present disclosure include a system for controlling operating parameters of the welding system 10. Specifically, the disclosed welding system 10 includes a dual input device user interface 38 configured for dual input device control and single input device control. The dual input device user interface 38 and multiple control schemes described above enable the use of a single welder (e.g., power source 16 and/or wire feeder 20) with multiple welding processes (e.g., MIG and FCAW), while also enabling simplified and flexible operability for a user. For example, in a first control mode, only one of the two input devices 50 and 52 of the user interface 38 may be used to adjust operating parameters of the welding system 10 and, in a second control mode, both input devices 50 and 52 of the user interface 38 may be used to adjust operating parameters of the welding system 10. In the first control scheme (e.g., easy mode setting), the first input device 50 may be used to select a thickness or gauge of the work piece 14 welded by the welding system 10. In this first control scheme, control circuitry 30 of the welding system 10 may automatically select appropriate voltage and wire feed speed settings based on the selected thickness or gauge of the work piece 14. In the second control scheme, both input devices 50 and 52 of the user interface 38 are used to adjust operating parameters of the welding system 10. For example, in the second control scheme, the first input device 50 of the user interface 38 may be used to adjust a voltage output of the welding system 10, and the second input device 52 of the user interface 38 may be used to adjust a wife feed speed of the welding system 10.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A welding system, comprising:
a power source configured to generate power and deliver the power to a welding torch;
a welding wire feeder configured to advance wire electrode into the welding torch at a rate of advancement; and
an interface, comprising:
a first input device configured to receive an input relating to a parameter of the power and an input relating to a thickness of a material to be welded; and
a second input device configured to receive an input relating to the rate of advancement of the wire electrode.

2. The welding system of claim 1, comprising control circuitry configured to utilize the input relating to the thickness of the material to be welded when the second input device is in a first position.

3. The welding system of claim 2, wherein the control circuitry is configured to not utilize the input relating to the parameter of the power when the second input device is in the first position.

4. The welding system of claim 2, wherein the control circuitry is configured to not utilize the input relating to the rate of advancement of the wire electrode when the second input device is in the first position.

5. The welding system of claim 2, wherein the control circuitry is configured to utilize the input relating to the parameter of the power and the input relating to the advancement of the wire electrode when the second input device is not in the first position.

6. The welding system of claim 2, wherein the user interface comprises a visual indicator configured to provide a visual indication when the second input device is in the first position or when the second input device is not in the first position.

7. The welding system of claim 1, wherein the user interface comprises a first plurality of visual indicators arranged about the first input device and a second plurality of visual indicators arranged about the second input device.

8. The welding system of claim 7, wherein the user interface comprises a first plurality of visual settings, wherein each of the first plurality of visual settings is representative of a setting relating to the parameter of the power, and each of the first plurality of visual settings corresponds to a respective one of the first plurality of visual indicators, and wherein the user interface comprises a second plurality of visual settings, wherein each of the second plurality of visual settings is representative of a setting relating to the thickness of the material to be welded, and each of the second plurality of visual settings corresponds to a respective one of the first plurality of visual indicators.

9. The welding system of claim 8, wherein the user interface comprises a third plurality of visual settings, wherein each of the third plurality of visual settings is representative of a setting relating to the rate of advancement of the wire electrode, and each of the third plurality of visual settings corresponds to a respective one of the second plurality of visual indicators.

10. A welding system, comprising:
a power source configured to generate power and deliver the power to a welding torch;
an interface, comprising:
a first input device configured to receive an input relating to a parameter of the power and an input relating to a thickness of a material to be welded; and
a second input device configured to receive an input relating to rate of advancement of a wire electrode; and
control circuitry configured to output control signals to the power source and a welding wire feeder based on the input relating to a thickness of a material to be welded when the second input device is in a first position.

11. The welding system of claim 10, comprising the welding wire feeder, wherein the welding wire feeder is configured to advance the wire electrode into the welding torch at the rate of advancement.

12. The welding system of claim 10, wherein the control circuitry is configured to output control signals to the power source and the welding wire feeder based on the input relating to a parameter of the power and the input relating to the rate of advancement of the wire electrode when the second input device is not in the first position.

13. The welding system of claim 10, wherein the first input device comprises a first adjustable device, and the second input device comprises a second adjustable device.

14. The welding system of claim 10, wherein the control circuitry is configured to automatically select an output relating to the parameter of the power and an output relating to the advancement of the wire electrode based on the input relating to a thickness of a material to be welded when the second input device is in the first position.

15. The welding system of claim 10, wherein the second input device comprises an adjustable device comprising an integrated switch.

16. A method, comprising:
setting a material thickness of a work piece to be welded based on adjustment of a first input device of a user interface of a welding system when a second input device of the user interface is in a first position;
setting a power output of the welding system based on adjustment of the first input device of the user interface of the welding system when the second input device of the user interface is not in the first position;
setting a wire feed speed output of the welding system based on adjustment of the second input device of the user interface when the second input device of the user interface is not in the first position; and
controlling operating parameters of the welding system in accordance with the settings of the material thickness of the work piece to be welded, the power output, and/or the wire feed speed output.

17. The method of claim 16, comprising automatically selecting the wire feed speed output and the power output based on the material thickness of the work piece with control circuitry of the welding system when the second input device is in the first position.

18. The method of claim 16, comprising outputting control signals to a power source of the welding system based on the power output and outputting control signals to a welding wire feeder of the welding system based on the wire feed speed output when the second input device is not in the first position.

19. The method of claim 16, comprising performing a flux core arc welding operation or a metal inert gas welding operation with the welding system when the second input device is in the first position.

20. The method of claim 16, comprising performing a metal inert gas welding operation or a flux core arc welding operation with the welding system when the second input device is not in the first position.

21. A system, comprising:
control circuitry of a welding system, wherein the control circuitry is configured to:
receive a first signal from a first input device, wherein the first signal is indicative of a material thickness of a work piece to be welded or is indicative of a desired power output of the welding system;
receive a second signal from a second input device, wherein the second signal is indicative of a desired wire feed speed of the welding system or is indicative of a simplified operating mode of the welding system;
output control signals to the welding system based on the first signal and the second signal, wherein the first signal is indicative of the desired power output of the welding system when the second signal is indicative of the desired wire feed speed of the welding system, and the first signal is indicative of the material thickness of the work piece to be welded when the second signal is indicative of the simplified operating mode of the welding system.

22. The system of claim 21, wherein the control circuitry is configured to automatically select a power output control signal and a wire feed speed control signal based on the first signal when the second signal is indicative of the simplified operating mode of the welding system.
